(19) United States
(12) Patent Application Publication
(10) Pub. No.: US 2024/0104831 A1
(43) Pub. Date: Mar. 28, 2024

(54) TECHNIQUES FOR LARGE-SCALE THREE-DIMENSIONAL SCENE RECONSTRUCTION VIA CAMERA CLUSTERING

(71) Applicant: NVIDIA CORPORATION, Santa Clara, CA (US)

(72) Inventors: Yen-Chen LIN, Cambridge, MA (US); Valts BLUKIS, Kirkland, WA (US); Dieter FOX, Seattle, WA (US); Alexander KELLER, Berlin (DE); Thomas MUELLER-HOEHNE, Zurich (CH); Jonathan TREMBLAY, Redmond, WA (US)

(21) Appl. No.: 18/330,271

(22) Filed: Jun. 6, 2023

Related U.S. Application Data
(60) Provisional application No. 63/377,247, filed on Sep. 27, 2022.

(51) Int. Cl. G06T 15/20; G06T 7/55; G06T 15/00

(52) U.S. Cl. CPC G06T 15/205; G06T 7/55; G06T 15/005; G06T 2200/08

(57) ABSTRACT

One embodiment of a method for generating representations of scenes includes assigning each image included in a set of images of a scene to one or more clusters of images based on a camera pose associated with the image, and performing one or more operations to generate, for each cluster included in the one or more clusters, a corresponding three-dimensional (3D) representation of the scene based on one or more images assigned to the cluster.

### CROSS-REFERENCE TO RELATED APPLICATIONS

This application claims priority benefit of the United States Provisional Patent Application titled, “LARGE-SCALE NEURAL SCENE RECONSTRUCTION VIA CAMERA CLUSTERING AND DYNAMIC OBJECT MASKING,” filed on Sep. 27, 2022, and having Ser. No. 63/377,247. The subject matter of this related application is hereby incorporated herein by reference.

### BACKGROUND

### Technical Field

Embodiments of the present disclosure relate generally to computer science and computer graphics and, more specifically, to techniques for large-scale three-dimensional scene reconstruction via camera clustering.

### Description of the Related Art

Three-dimensional (3D) representations of scenes, which can be viewed from various positions and orientations, are becoming increasingly widespread. For example, 3D representations of scenes can be used to create virtual worlds, capture real-world environments, and reconstruct 3D digital maps, among other things. One conventional approach for generating a 3D representation of a scene is to train a neural radiance field (NeRF) using images captured within the scene. A NeRF is an artificial neural network that can be trained to take as inputs the coordinates of a point in space and a viewing direction, and to output a color value and a density associated with the point and direction. Once trained, the NeRF can be used to render images via, for example, a ray tracing technique.

One drawback of some conventional 3D representations of scenes, including conventional NeRFs, is that these 3D representations include a relatively high level of detail near a center point and progressively less detail away from the center point. For example, when images that are far away from the center point of a conventional NeRF are used to train the NeRF, every pixel in those images can end up covering a large cone of the 3D volume associated with the NeRF. As a result, the NeRF can include less detail away from the center point. In addition, some data structures for rendering images using a conventional 3D representation have lower resolution away from a center point of the 3D representation. When such data structures are used to render images of regions within a scene that are far from the center point, the rendered images can appear blurry or otherwise lack detail, thereby reducing overall image quality. Due to the foregoing drawbacks, some conventional 3D representations are only suitable for rendering images of small scenes in which a viewer cannot move far away from center points of those conventional 3D representations, but not large-scale scenes, such as entire buildings or cities, in which a viewer can move far away from the center points of those conventional 3D representation.

As the foregoing illustrates, what is needed in the art are more effective techniques for generating 3D representations of scenes.

### SUMMARY

One embodiment of the present disclosure sets forth a computer-implemented method for generating representations of scenes. The method includes assigning each image included in a set of images of a scene to one or more clusters of images based on a camera pose associated with the image. The method further includes performing one or more operations to generate, for each cluster included in the one or more clusters, a corresponding three-dimensional (3D) representation of the scene based on one or more images assigned to the cluster.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that images rendered using the disclosed techniques can be less blurry and can include more detail relative to images rendered using conventional approaches, particular for large-scale scenes. In addition, the disclosed techniques permit processing parallelization, which can reduce the time required to generate 3D representations and to render images using those 3D representations relative to conventional approaches. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a more detailed block diagram of the server of FIG. 1, according to various embodiments;

FIG. 3 is a more detailed illustration of the three-dimensional (3D) representation generator of FIG. 1, according to various embodiments;

FIG. 4 illustrates an exemplar clustering of images, according to various embodiments;

FIG. 5 illustrates how exemplar 3D representations can be used to render images, according to various embodiments;

FIG. 6A illustrates an exemplar image of a scene rendered using a Neural Radiance Field (NeRF), according to the prior art;

FIG. 6B illustrates an exemplar image of a scene rendered using a set of NeRFs, according to various embodiments;

FIG. 7 is a flow diagram of method steps for generating a set of 3D representations of a scene, according to various embodiments;

FIG. 8 is a flow diagram of method steps for assigning images to one or more clusters based on camera poses, according to various embodiments; and

FIG. 9 is a flow diagram of method steps for rendering an image of a scene, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating and utilizing a set of 3D representations, such as a set of neural radiance fields (NeRFs), of a scene. In some embodiments, a 3D representation generator segments out, from a set of captured images of the scene, predefined classes of objects that can move within the scene. Then, the 3D representation generator determines camera poses associated with each image in the set of captured images. The 3D representation generator assigns each of the images to one or more clusters based on an associated camera pose. For each cluster, the 3D representation generator generates a 3D representation based on the images assigned to the cluster. Once generated, the 3D representations can be streamed, or otherwise provided for use, and images can be rendered from different positions and view directions of a viewer using the 3D representations.

The techniques disclosed herein for generating sets of 3D representations of a scene have many real-world applications. For example, those techniques could be used to generate a set of 3D representations of a real-world environment, such as for historic preservation or creating a digital twin of the real-world environment. As another example, those techniques could be used to generate a set of 3D representations that provides a virtual world. As another example, those techniques could be used to generate a set of 3D representations for computational photography. As yet another example, those techniques could be used to generate a set of 3D representations that provide a 3D digital map for robots or autonomous vehicles.

The above examples are not in any way intended to be limiting. As persons skilled in the art will appreciate, as a general matter, the techniques for generating and utilizing a set of 3D representations can be implemented in any suitable application.

### System Overview

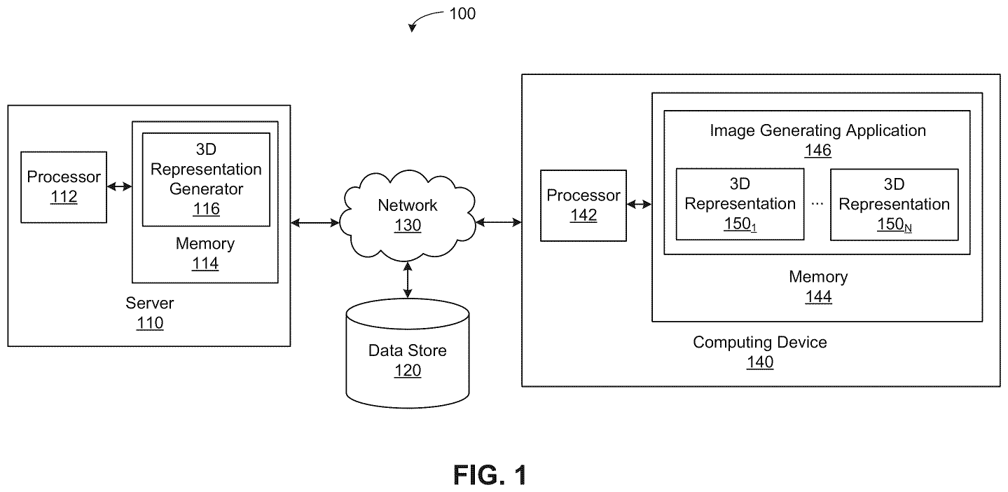

FIG. 1 is a block diagram illustrating a computer system 100 configured to implement one or more aspects of the various embodiments. As shown, the system 100 includes a server 110, a data store 120, and a computing device 140 in communication over a network 130, which can be a wide area network (WAN) such as the Internet, a local area network (LAN), or any other suitable network.

As shown, a 3D representation generator 116 executes on a processor 112 of the server 110 and is stored in a system memory 114 of the server 110. The processor 112 receives user input from input devices, such as a keyboard or a mouse. In operation, the processor 112 is the master processor of the server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

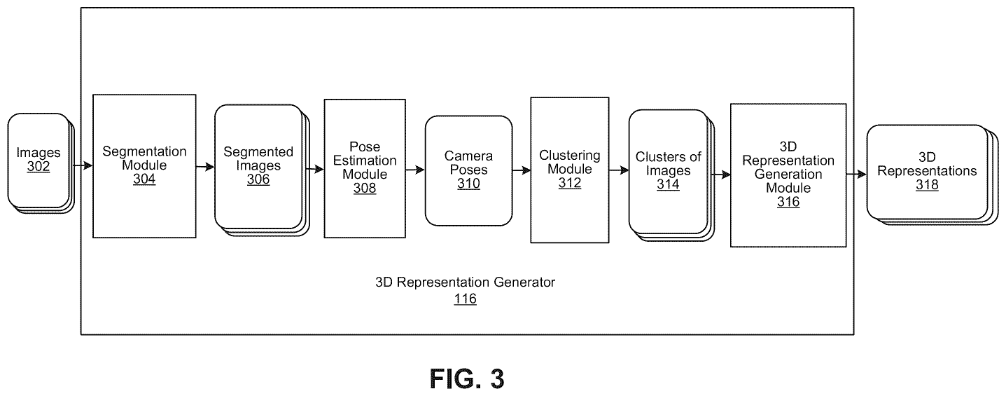

In some embodiments, the 3D representation generator 116 is configured to generate one or more 3D representations, including 3D representations 150_{1-N} (referred to herein collectively as 3D representations 150 and individually as a 3D representation 150). Example 3D representations and techniques for generating the same as discussed in greater detail below in conjunction with FIGS. 3-4 and 7-8. Data used to generate the 3D representations 150 and/or the 3D representations 150, themselves, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the server 110 can include the data store 120.

As shown, an application 146 that utilizes the 3D representations 150 is stored in a system memory 144, and executes on a processor 142, of the computing device 140. Once generated, the 3D representations 150 can be deployed for use in any suitable application(s) in some embodiments. For example the 3D representations 150 could be used to provide a representation of a real-world environment, such as for historic preservation or creating a digital twin of the real-world environment. As another example, the 3D representations 150 could be used to provide a virtual experience, such as a real-estate demo or virtual reality space. As another example, the 3D representations 150 could be used in computational photography. As yet another example, the 3D representations 150 could be used to provide a 3D digital map for robots or autonomous vehicles.

In some embodiments, one or more of the 3D representations 150 can be streamed, or otherwise provided for use, and images can be rendered from different positions and view directions of a viewer using the 3D representations 150.

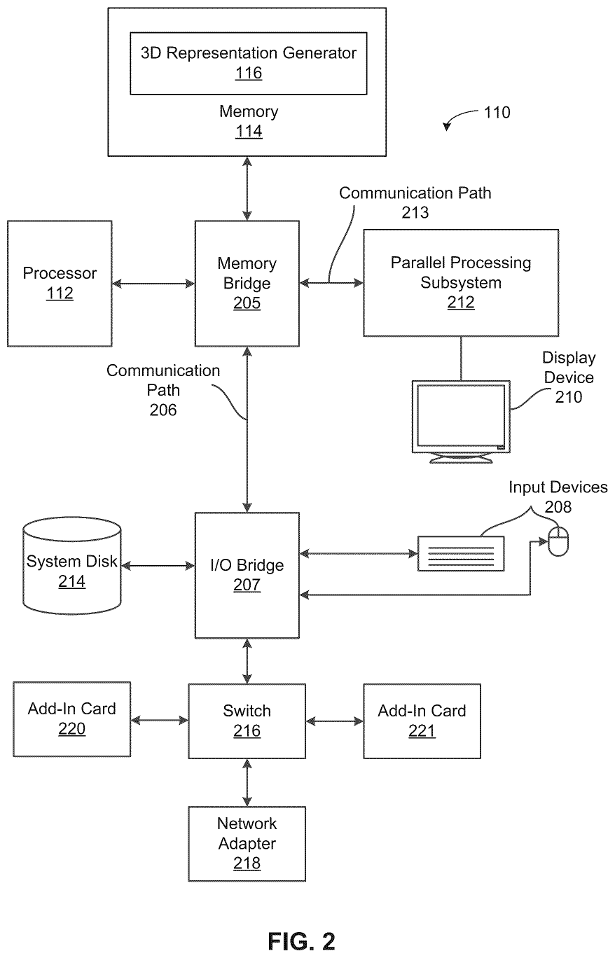

FIG. 2 is a more detailed block diagram of the server 110 of FIG. 1, according to various embodiments. As persons skilled in the art will appreciate, the server 110 can be any type of technically feasible computer system, including, without limitation, a server machine, a server platform, a desktop machine, laptop machine, a hand-held/mobile device, or a wearable device. In some embodiments, the server 110 is a server machine operating in a data center or a cloud computing environment that provides scalable computing resources as a service over a network. In some embodiments, the computing device 140 can include similar components as the server 110.

In various embodiments, the server 110 includes, without limitation, the processor 112 and the memory 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard or a mouse, and forward the input information to processor 112 for processing via communication path 206 and memory bridge 205. In some embodiments, server 110 may be a server machine in a cloud computing environment. In such embodiments, server 110 may not have input devices 208. Instead, server 110 may receive equivalent input information by receiving commands in the form of messages transmitted over a network and received via the network adapter 218. In one embodiment, switch 216 is configured to provide connections between I/O bridge 207 and other components of the server 110, such as a network adapter 218 and various add-in cards 220 and 221.

In one embodiment, I/O bridge 207 is coupled to a system disk 214 that may be configured to store content and applications and data for use by processor 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within parallel processing subsystem 212. In other embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 114 includes at least one device driver configured to manage the processing operations of the one or more PPUs within parallel processing subsystem 212. In addition, the system memory 114 includes the 3D representation generator 116. Although described herein primarily with respect to the 3D representation generator 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on chip (SoC).

In one embodiment, processor 112 is the master processor of server 110, controlling and coordinating operations of other system components. In one embodiment, processor 112 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 114 could be connected to processor 112 directly rather than through memory bridge 205, and other devices would communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Large-Scale 3D Scene Reconstruction Via Camera Clustering

FIG. 3 is a more detailed illustration of the 3D representation generator 116 of FIG. 1, according to various embodiments. As shown, the 3D representation generator 116 includes a segmentation module 304, a pose estimation module 308, a clustering module 312, and a 3D representation generation module 316. In operation, the 3D representation generator 116 takes as input images 302 of a scene. The images 302 can include frames of a video and/or standalone images that are captured from various positions and/or vantage points using any technically feasible camera device(s). For example, the images 302 could be frames of a video captured by the camera of a mobile device that a user holds while walking around a scene.

Given the images 302, the segmentation module 304 segments out predefined classes of objects from the images 302 to generate segmented images 306. In some embodiments, the predefined classes of objects include classes of objects that can move within the scene, such as people, animals, vehicles, etc. In some embodiments, the predefined classes of objects can be segmented out in any technically feasible manner. For example, in some embodiments, the segmentation module 304 can employ a trained semantic segmentation machine learning model to identify pixels in the images 302 that belong to the classes of objects. Then, the segmentation module 304 can mask out the identified pixels from being used to generate 3D representations. For example, in some embodiments, the segmentation module 304 can mark the identified pixels such that those pixels are not used to train neural radiance fields (NeRFs). It should be understood that, by segmenting out certain classes of objects that move, 3D representations can be generated of a static environment that does not include the objects that move. Further, even though pixels of the images 302 that are associated with the classes of objects are not used to generate the 3D representations, the remaining pixels can cover all of the static environment if the objects occlude different portions of the environment in different images 302.

The pose estimation module 308 determines, from the segmented images 306, camera poses 310 associated with each segmented image. The pose estimation module 308 can determine camera poses in any technically feasible manner. In some embodiments, the pose estimation module 308 can apply a structure-from-motion (SfM) or simultaneous localization and mapping (SLAM) technique to determine camera poses associated with the segmented images 306. For example, in some embodiments, the COLMAP technique can be applied to determine a camera pose for each image in the segmented images 306. In some embodiments, the pose estimation module 308 does not use pixels in the images that were segmented out as being associated with classes of objects that can move to determine the camera poses, as pixels associated with objects that move may not correspond to the same 3D positions in different images. In some other embodiments, pose estimation can be performed prior to segmenting out predefined classes of objects from the images 302. Although described herein primarily with respect to the pose estimation module 308 determining the camera poses 310 associated with each segmented image 306, in some embodiments, the 3D representation generator 116 can receive camera poses from another source, such as an augmented reality toolkit that is included in some mobile devices and can provide camera poses to the 3D representation generator 116.

The clustering module 312 assigns each of the segmented images 306 to one or more clusters based on the camera poses 310. The segmented images 306 can be assigned to cluster(s) in any technically feasible manner in some embodiments. In some embodiments, the clustering module 312 computes, for each segmented image, a point that is a distance in front of a camera used to capture the segmented image. The distance can be set by a user or automatically determined, and the clustering module 312 can compute a point for each segmented image based on a pose of the camera used to capture the segmented image. In some embodiments, the clustering module 312 can compute look-at points that are a fixed distance, such as one meter, in front of each camera. In some embodiments, the clustering module 312 can compute a distance for each camera as an average of sparse depths from the camera to geometry in front of the camera that is determined via, e.g., a SfM technique. Using the points in front of the cameras, in some embodiments, the clustering module 312 determines a number of clusters having associated cluster centers via a clustering technique, such as the k-means clustering technique. Thereafter, the clustering module 312 assigns segmented images 306 associated with points in front of cameras that are within a threshold of each cluster center to the cluster having the cluster center. If more than a predefined number of segmented images 306 are assigned to any given cluster, then the clustering module 312 adjusts the thresholds associated with clusters that include more than the predefined number of segmented images 306, and the clustering module 312 assigns segmented images 306 associated with points that are within the adjusted thresholds of the associated cluster centers to those clusters. The foregoing process is repeated until no cluster is assigned more than the predefined number of segmented images 306. The number of segmented images 306 per cluster is a metric that can be used to determine how many clusters are desired. In some other embodiments, a number of clusters can be determined in any technically feasible manner, such as based on view direction coverage and/or the spread of look-at points.

In some embodiments, in addition to clustering in 3D space based on points in front of cameras used to capture images, described above, the clustering module 312 determines whether the segmented images 306 assigned to each cluster provide sufficient coverage across view directions. For example, in some embodiments, if not all view directions are covered for a given cluster, then additional segmented images 306, which can be associated with points in front of cameras that are not within the threshold previously used to assign segmented images 306 to the given cluster, can be assigned to the given cluster in order to cover all view directions. Whether and how many additional segmented images 306 are added will generally depend on the field of view (FOV) of the cameras, because fewer segmented images 306 are needed to cover all view directions when cameras used to capture the segmented images 306 have larger FOVs, and vice versa.

In some embodiments, the clustering module 312 can assign each of the segmented images 306 to one or more clusters without considering points in front of cameras used to capture the segmented images 306. For example, in some embodiments, clustering module 312 can assign each of the segmented images 306 to one or more clusters based on the convergence of view rays associated with cameras used to capture the segmented images 306. In such cases, the clustering module 312 can compute focal points that are closest to the view rays, and cluster the segmented images 306 based on the focal points.

The 3D representation generation module 316 generates a set of 3D representations 318 of the scene captured in the segmented images 306. In some embodiments, the 3D representation generation module 316 generates a distinct 3D representation for each cluster of images 314 based on segmented images 306 assigned to the cluster, and a size of the 3D representation that is generated for each cluster can be based on a size of the cluster. When generating the 3D representation for each cluster of images 314, the 3D representation generation module 316 does not use pixels in the segmented images 306 that were segmented out by the segmentation module 304. The process of generating the set of 3D representations is parallelizable. For example, in some embodiments, different processors (e.g., different GPUs) can be used to generate different 3D representations in parallel.

In some embodiments, the 3D representation generation module 316 trains a distinct NeRF model for each cluster of images, and the 3D representation generation module 316 does not trace rays associated with pixels in the segmented images 306 that were segmented out when training the NeRFs. It should be understood that, when ray tracing is used in the inverse rendering process that produces the NeRFs (or other 3D representations), by not tracing any rays on segmented pixels, those pixels are effectively not taken into account in the NeRFs (or other 3D representations), i.e., the NeRFs (or other 3D representations) are not optimized to produce those pixels. In some embodiments, each NeRF is an artificial neural network that is trained to take the coordinates of a point in space and a viewing direction as inputs, and to output a color value and a density associated with the point and direction. Each NeRF can be trained in any technically feasible manner, including via known techniques, in some embodiments. For example, the instant NGP (neural graphics primitive), Neural RGBD, DeepSDF, VoISDF (volume rendering of neural implicit surfaces), or traditional NeRF techniques could be used by the 3D representation generation module 316 to train each NeRF. In some embodiments, each NeRF can be generated to have a center at a focal point that is the closest point to view rays associated with cameras used to capture segmented images in the cluster used to generate the NeRF. In some embodiments, each NeRF can be generated to have a center that is a center of the cluster used to generate the NeRF. In some embodiments, each NeRF can be generated to have a center that is a mean of all 3D locations of the centers of segmented images in the cluster used to generate the NeRF. In some embodiments, the coordinate system used to train each NeRF can be scaled depending on how large the cluster of segmented images is, i.e., the size of NeRF that is generated for each cluster can be based on a size of the cluster. In some embodiments, a sparse point cloud generated with triangulation is used as additional depth supervision to optimize the generated NeRFs. Though the NeRFs can primarily be used to perform view synthesis by rendering RGB (red, green, blue) images, the volumetric rendering equation can be modified slightly to produce the expected termination depth of each ray by replacing the predicted color with the distance, and such an additional supervision can effectively remove floaters in the empty volume of the NeRFs.

Although described herein primarily with respect to NeRFs as a reference example, in some embodiments, the 3D representation generation module 316 can generate any technically feasible 3D representations that each include a relatively high resolution near a center point of the 3D representation and progressively lower resolution away from the center point. Examples of 3D representations that can be generated in some embodiments include other neural graphics primitives (NGPs) such as signed distance functions (SDFs) that can be parametrized by NeRFs, 3D representations using points, 3D representations using surfels (Surface Elements), 3D representations using Gaussians, 3D representations using tetrahedra, and 3D representations using triangles.

More formally, processing of the images 302 by the 3D representation generator 116 can be as follows in some embodiments. Given the images 302 and corresponding camera poses, the placement locations of 3D representations can be automatically computed by obtaining a sparse point cloud of the scene using triangulation with the N posed images {Iᵢ}ᵢ₌₁^{N}. Then, a point pᵢ, such as a look-up point (i.e., the image center's corresponding 3D location), associated with each image Iᵢ can be computed, and clustering can be performed to determine which views should belong to the same 3D representations based on such points.

It should be understood that the 3D representation that is generated for each cluster of images 314 can be used to reconstruct a local region in space and/or to reconstruct all of space with high resolution in the reconstruction's center and progressively lower resolution outward. Further, because each 3D representation is generated from a cluster of images that are relatively close to a high-resolution central region of the 3D representation, pixels of the images can cover relatively small cones of a 3D volume associated with the 3D representation. As a result, the 3D representation can provide higher reconstruction resolution than a single 3D representation that is generated using all of the images 302. In particular, the resolution of the reconstruction using the set of 3D representations can more closely match the resolution of the images used to generate the set of 3D representations.

Once generated, the set of 3D representations can be used to render images given the position and view directions of a viewer. Any technically feasible heuristics can be used to select one or more 3D representations used to render images in some embodiments. In some embodiments, an application (e.g., the image generating application 146) determines a closest 3D representation whose center is closer to a position of the viewer than the center of any other 3D representation is, and the application renders an image using the closest 3D representation. Any technically feasible distance metric can be used to determine the closest 3D representation in some embodiments. In some embodiments, each 3D representation is associated with a bounding box, and an application (1) determines which bounding boxes a position of the viewer is in, (2) selects, among the 3D representations associated with the determined bounding boxes, a closest 3D representation to the position of the viewer. In some embodiments, a nearest neighbor technique can be used to select a 3D representation based on a viewer position and to switch between 3D representations when the viewer position moves. In some embodiments, an application determines a closest 3D representation in terms of position in Euclidean space and view direction to the viewer, and the application renders an image using the closest 3D representation. In some embodiments, an application determines multiple closest 3D representations to a position and/or view direction of a viewer, and the application interpolates (i.e., blends) images rendered using the multiple closest 3D representations, with the interpolation being weighted based on distance from the viewer to centers of the multiple closest 3D representations. In some embodiments, an application determines multiple closest 3D representations to a position and/or view direction of a viewer, and the application performs a dithering technique in which different portions of an image are rendered using different 3D representations from the multiple closest 3D representations. In such cases, 3D representations that are closest to the position and/or view direction of the viewer can be used to render more pixels of the image, and vice versa. In some embodiments, an application determines four closest 3D representations to a viewer position, which form a tetrahedron, and the application interpolates images rendered using the four closest 3D representations, with the interpolation being weighted based on barycentric coordinates of the viewer within the tetrahedron. Using the four closest 3D representations limits the number of images that are rendered and interpolated to four. It should be understood that using more than one 3D representation to render images that are then interpolated can provide smoother transitions between 3D representations, but can also increase the computational cost. In addition, when more than one 3D representation is used to render images that are then interpolated, the rendering process is parallelizable. For example, in some embodiments, different processors (e.g., different GPUs) can be used to render each image using a different 3D representation.

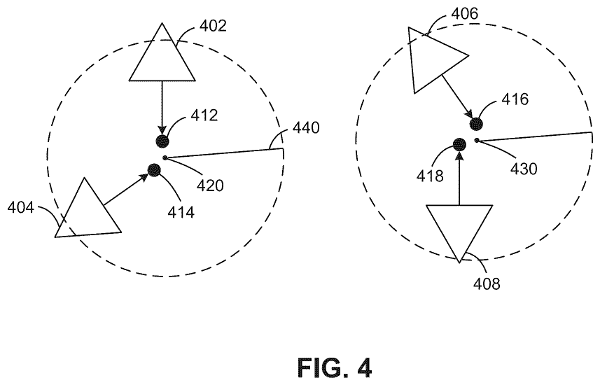

FIG. 4 illustrates an exemplar clustering of images, according to various embodiments. As shown, the 3D representation generator 116 computes a look-at point 412, 414, 416, and 418 associated with each image captured by a camera 402, 404, 406, and 408, respectively. In some embodiments, certain classes of objects, such as objects that can move, can also be segmented out of the images, as described above in conjunction with FIG. 3. Illustratively, each look-at point 412, 414, 416, and 418 is a fixed distance (e.g., one meter) in front of the camera 402, 404, 406, and 408, respectively. In some embodiments, any suitable points that are specified by a user or automatically determined, view directions associated with cameras, etc. can be used for clustering, as described above in conjunction with FIG. 3.

After computing the look-at points 412, 414, 416, and 418, the 3D representation generator 116 clusters the look-at points 412, 414, 416, and 418 using a clustering technique. Any technically feasible clustering technique, such as k-means clustering, can be used in some embodiments. Further, the 3D representation generator 116 can cluster the look-at points 412, 414, 416, and 418 to generate any suitable number of clusters in some embodiments. Two clusters having cluster centers 420 and 430 are shown for illustrative purposes.

After clustering the look-at points 412, 414, 416, and 418, the 3D representation generator 116 assigns images associated with the look-at points 412, 414, 416, and 418 that are within a threshold (e.g., threshold 440) of each cluster center 420 and 430 to the cluster having the cluster center 420 and 430. Illustratively, images captured by the cameras 402 and 404 are added to a cluster having the cluster center 420, and images captured by the cameras 406 and 408 are added to a cluster having the cluster center 430. Although the image captured by each of the cameras 402, 404, 406, and 408 is shown as being assigned to a single cluster, in some embodiments, each image can be assigned to one or more clusters when the image is within a threshold of each cluster to which the image is assigned. It should be understood that the assignment of each image to potentially more than one cluster is different from some conventional clustering techniques, such as k-means clustering, that would assign each image to a single cluster. In addition, the overlapping assignment of some images to more than one cluster can provide a relatively smooth transition between 3D representations generated using images assigned to the clusters.

In some embodiments, the threshold used to assign images to clusters is based on differences between positions and/or view directions of the look-at points 412, 414, 416, and 418 and the center of each cluster. In some embodiments, the 3D representation generator 116 further determines whether more than a predefined number of images have been assigned to any cluster, in which case the 3D representation generator 116 adjusts the thresholds of clusters that include more than the predefined number of images and re-assigns images to those clusters based on the adjusted threshold.

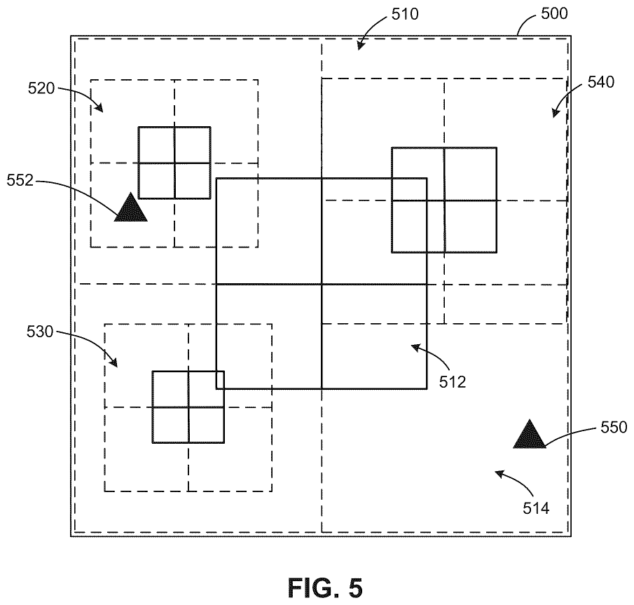

FIG. 5 illustrates how exemplar 3D representations can be used to render images, according to various embodiments. As shown, a set of four 3D representations 510, 520, 530, and 540 have been generated to represent a scene 500. In some embodiments, each of the 3D representations 510, 520, 530, and 540 models the scene 500 up to infinity. However, a central region (e.g., region 512) of a data structure used to render each 3D representation 510, 520, 530, or 540, shown with bolded lines, includes greater resolution than an outer region (e.g., region 514) of the data structure used to render each 3D representation 510, 520, 530, or 540, shown with ghosted lines. Illustratively, the central region 512 and outer region 514 of the data structure used to render the 3D representation 510 are larger than the central and outer regions, respectively, of the data structure used to render the 3D representation 540, which are in turn larger than the central and outer regions, respectively, of the data structure used to render the 3D representations 520 and 530. As described, the 3D representations can be generated with different sizes based on the sizes of image clusters used to generate the 3D representations. The different sizes of the central and outer regions of data structures used to render the 3D representations 510, 520, 530, and 540 can be used to account for varying amounts of detail in those regions that can be modeled. It should be noted that, because multiple 3D representations 510, 520, 530, and 540 have been generated, the set of 3D representations 510, 520, 530, and 540 provide higher resolution in the associated central regions, whereas a single 3D representation would only provide higher resolution in one central region associated with the single 3D representation.

As shown, when a viewer is located at a position 550, the viewer is within a bounding box, shown with a ghosted line, that is associated with the 3D representation 510 and bounds the outer region 514 of the data structure used to render the 3D representation 510. In some embodiments, an application (e.g., image generating application 146) renders an image using the 3D representation 510 for the viewer at position 550. In some embodiments, a server (e.g., server 110) only streams, or otherwise transmits, the 3D representation 510 to a computing device (e.g., computing device 140) when the viewer is at the position 550, because only the 3D representation 510 is used to render an image.

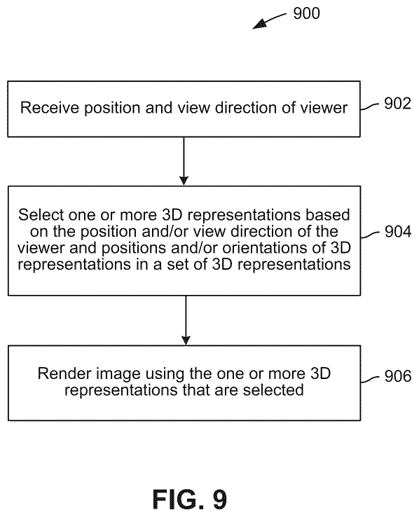

When the viewer moves to position 552, the viewer is also within a bounding box, shown with a ghosted line, that is associated with the 3D representation 520 and bounds an outer region of the data structure used to render the 3D representation 520. In addition, the viewer is closer to a center of the 3D representation 520 than a center of any other 3D representation 510, 530, or 540. In some embodiments, an application renders an image using the 3D representation 520 for the viewer at position 552. In some embodiments, a server only streams, or otherwise transmits, the 3D representation 520 to a computing device when the viewer is at position 552, because only the 3D representation 520 is used to render an image. Although described with respect to using only one of the 3D representations 510, 520, 530, and 540 to render an image of the scene, in some embodiments, multiple images can be rendered using more than one 3D representation 510, 520, 530, and 540 that is closest to a viewer, and the multiple images can be interpolated to generate an interpolated image, as described herein in conjunction with FIGS. 3 and 9.

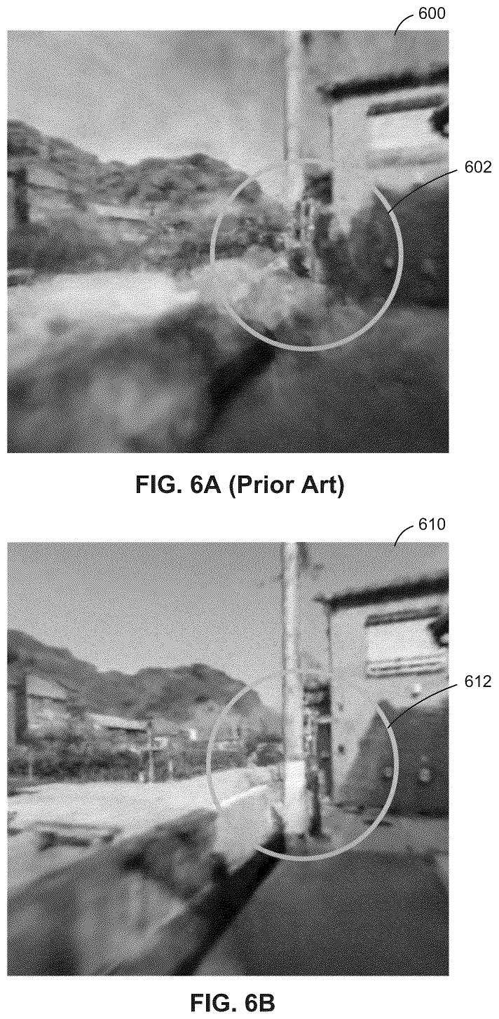

FIG. 6A illustrates an exemplar image 600 of a scene rendered using a NeRF, according to the prior art. As shown, the image 600 depicts a portion of a scene that is relatively far from a center of the NeRF. Illustratively, the scene includes approximately 0.5 square kilometers of a city, and the NeRF was trained using approximately 2000 training images captured around the city.

Because the portion of the city depicted in the image 600 is relatively far from a center of the NeRF, the image 600 appears blurry. As described, conventional NeRFs and data structures for rendering the NeRFs provide relatively high resolution near centers of the NeRFs and progressively lower resolution away from the centers, with the assumption that viewers will be located at the centers and not notice low resolution details away from the centers. In addition, details of a pillar are missing from a portion 602 of the image 600, because a corresponding portion of a data structure that was used to render the image 600 has a low resolution that indicates the portion 602 of the image 600 is empty.

FIG. 6B illustrates an exemplar image 610 of a scene rendered using a set of NeRFs, according to various embodiments. As shown, the image 600 is less blurry relative to the image 600, because the image 610 was rendered using a NeRF from the set of NeRFs whose center is closest to the viewer. In addition, details of a pillar are included in a portion 612 of the image 610. Experience has shown that a set of NeRFs, trained using images that are clustered according to techniques disclosed herein, can achieve greater reconstruction quality than a single NeRF that includes the same number of parameters than the set of NeRFs combined.

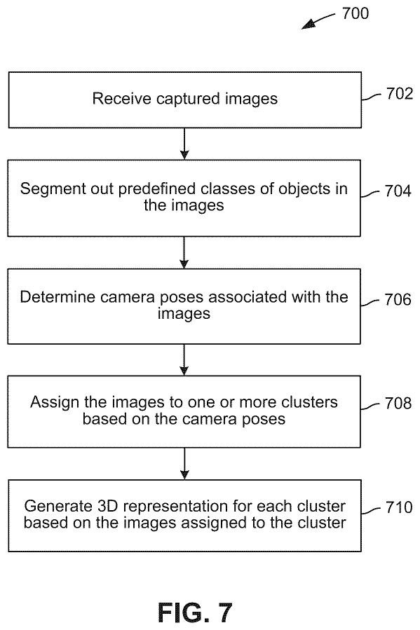

FIG. 7 is a flow diagram of method steps for generating a set of 3D representations of a scene, according to various embodiments. Although the method steps are described in conjunction with the systems of FIGS. 1-3, persons skilled in the art will understand that any system configured to perform the method steps in any order falls within the scope of the present embodiments.

As shown, a method 700 begins at step 702, where the 3D representation generator 116 receives multiple captured images of a scene. As described, the multiple captured images can include frames of a video and/or standalone images that are captured from various positions and/or vantage points.

At step 704, the 3D representation generator 116 segments out predefined classes of objects in the images. In some embodiments, the predefined classes of objects include classes of objects that can move within the scene, such as people, animals, vehicles, etc. In some embodiments, the predefined classes of objects can be segmented out in any technically feasible manner, such as using a trained semantic segmentation machine learning model to identify pixels within the images that belong to the classes of objects and generating a mask indicating that the identified pixels are not to be used in generating 3D representations.

At step 706, the 3D representation generator 116 determines camera poses associated with the images. In some embodiments, the 3D representation generator 116 can determine the camera poses in any technically feasible manner, such as by applying a SfM or SLAM technique to the images in order to determine associated camera poses. In such cases, the 3D representation generator 116 does not use pixels in the images that were segmented out at step 704 to determine the camera poses.

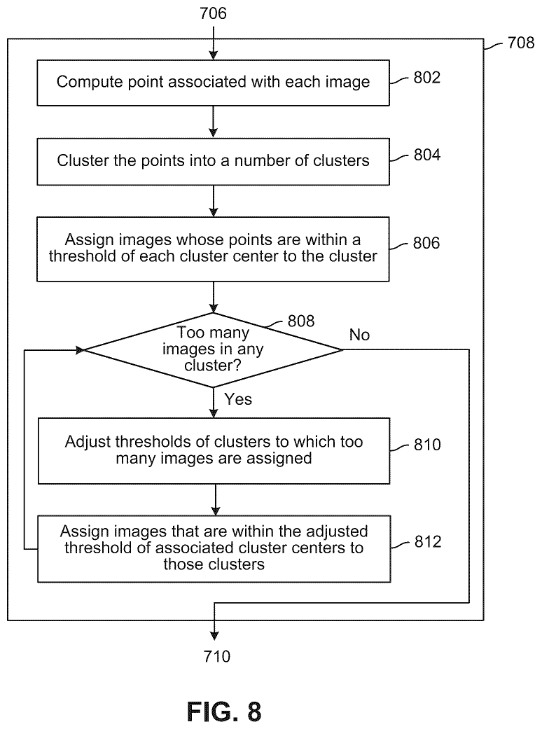

At step 708, the 3D representation generator 116 assigns the images (with the predefined classes of objects segmented out) to one or more clusters based on the camera poses. In some embodiments, the 3D representation generator 116 assigns the images to the one or more clusters by clustering the images in 3D space based on points in front of cameras used to capture the images, according to the steps described below in conjunction with FIG. 8. In some embodiments, in addition to clustering the images in 3D space, the 3D representation generator 116 determines whether the images assigned to each cluster provide sufficient coverage across view directions. In such cases, if not all view directions are covered for a given cluster, then additional images can be assigned to the given cluster in order to cover all view directions. In some other embodiments, the clustering module 312 can assign each of the images to one or more clusters without considering points in front of cameras used to capture the images, such as by assigning each of the images to one or more clusters based on the convergence of view rays associated with cameras used to capture the images.

At step 710, the 3D representation generator 116 generates a 3D representation for each cluster based on the images assigned to the cluster. When generating the 3D representation for each cluster of images, the 3D representation generator 116 does not use pixels in the images that were segmented out at step 704. In some embodiments, any suitable 3D representation can be generated for each cluster in any technically feasible manner, including using known techniques. In some embodiments, a size of the 3D representation that is generated for each cluster can be based on a size of the cluster. In some embodiments, each 3D representation is a NeRF, and the 3D representation generator 116 trains the NeRF for each cluster based on images assigned to the cluster. In such cases, the 3D representation generator 116 does not trace rays associated with pixels in the images that were segmented out at step 704 when training the NeRFs. In addition, in some embodiments, a large NeRF model is trained first and then used to supervise the training of smaller NeRF models using images in different clusters, which can reduce computation costs. In some embodiment, rather than a NeRF, each 3D representation can be an NGP such as a SDF that is parametrized by a NeRF, a 3D representation using points, a 3D representation using triangles, a 3D representation using surfels (Surface Elements), a 3D representation using Gaussians, a 3D representation using tetrahedra, a 3D representation using triangles, or any other 3D representation that includes a relatively high resolution near a center point of the 3D representation and progressively lower resolution away from the center point.

FIG. 8 is a flow diagram of method steps for assigning the images to one or more clusters based on the camera poses at step 708, according to various embodiments. Although the method steps are described in conjunction with the systems of FIGS. 1-3, persons skilled in the art will understand that any system configured to perform the method steps in any order falls within the scope of the present embodiments.

As shown, at step 802, the 3D representation generator 116 computes a point associated with each image. In some embodiments, the point computed for each image can be a distance in front of a camera used to capture the image. As described, the distance can be set by a user or automatically determined, and the point for each image can be computed based on a pose of the camera used to capture the image. In some embodiments, the points can be look-at points that are a fixed distance, such as one meter, in front of each camera. In some embodiments, the point for each image can be at a distance from an associated camera that is an average of sparse depths from the camera to geometry in front of the camera that is determined via, e.g., a SfM technique.

At step 804, the 3D representation generator 116 clusters the points computed at step 802 into a number of clusters. In some embodiments, the 3D representation generator 116 can cluster the points into any suitable number of clusters and using any technically feasible clustering technique, such as using a k-means clustering technique.

At step 806, the 3D representation generator 116 assigns images associated with points that are within a threshold of the center of each cluster to the cluster. In some embodiments, the threshold is based on differences between positions and/or view directions associated with the points and the center of each cluster.

At step 808, determines whether too many images are assigned to any cluster. In some embodiments, the 3D representation generator 116 can determine whether more than a predefined number of images have been assigned to any given cluster. As described, the number of images per cluster is a metric that can be used to determine how many clusters are desired. In some other embodiments, the 3D representation generator 116 can determine a number of clusters in any technically feasible manner, such as based on view direction coverage and/or the spread of look-at points. In such cases, different termination heuristics than whether too many images are assigned to any cluster can be used. For example, in some embodiments, the termination heuristics can be whether the number of clusters is sufficiently large and/or the spread of points/view angles is sufficiently small.

If no cluster has too many images assigned to it, then the method 700 proceeds directly to step 710, where the 3D representation generator 116 generates a 3D representation for each cluster based on the images assigned to the cluster. On the other hand, if there are too many images in any cluster, then the method 700 continues to step 810, where the 3D representation generator 116 adjusts the thresholds of clusters to which too many images are assigned. Then, at step 812, the 3D representation generator 116 assigns images associated with points that are within the adjusted threshold of associated cluster centers to those clusters.

FIG. 9 is a flow diagram of method steps for rendering an image of a scene, according to various embodiments. Although the method steps are described in conjunction with the systems of FIGS. 1-3, persons skilled in the art will understand that any system configured to perform the method steps in any order falls within the scope of the present embodiments.

As shown, a method 900 begins at step 902, where the image generating application 146 receives a position and a view direction of a viewer. In some embodiments, the viewer is a user who is permitted to reposition and reorient himself or herself within a virtual scene.

At step 904, the image generating application 146 selects one or more 3D representations based on the position and/or view direction of the viewer and positions and/or orientations of 3D representations in a set of 3D representations. In some embodiments, the set of 3D representations can be generated according to the method 700, described above in conjunction with FIGS. 7-8. In some embodiments, the image generating application 146 can use any technically feasible heuristics to select one or more 3D representations at step 904. In some embodiments, the image generating application 146 can select a closest 3D representation whose center is closer to the position of the viewer than the center of any other 3D representation is, and the image generating application 146 renders an image using the closest 3D representation. As described, any technically feasible distance metric can be used to determine the closest 3D representation in some embodiments. In some embodiments, each 3D representations is associated with a bounding box, and the image generating application 146 (1) determines which bounding boxes the position of the viewer is in, (2) selects, among the 3D representations associated with the determined bounding boxes, a closest 3D representation to the position of the viewer. In some embodiments, the image generating application 146 can employ a nearest neighbor technique to select a 3D representation based on the viewer position and to switch between 3D representations when the viewer position moves. In some embodiments, the image generating application 146 selects a closest 3D representation in terms of position in Euclidean space and view direction to the viewer, and the image generating application 146 renders an image using the closest 3D representation. In some embodiments, the image generating application 146 selects multiple closest 3D representations to the position and/or view direction of a viewer, and the application interpolates images rendered using the multiple closest 3D representations, with the interpolation being weighted based on distance from the viewer to centers of the multiple closest 3D representations. In some embodiments, the image generating application 146 selects multiple closest 3D representations to the position and/or view direction of a viewer, and the image generating application 146 performs a dithering technique in which different portions of an image are rendered using different 3D representations from the multiple closest 3D representations. In some embodiments, the image generating application 146 selects four closest 3D representations to the viewer position, which form a tetrahedron, and the image generating application 146 interpolates images rendered using the four closest 3D representations, with the interpolation being weighted based on barycentric coordinates of the viewer within the tetrahedron.

At step 906, the image generating application 146 renders an image using the one or more 3D representations that are selected. As described, in some embodiments, the image can be rendered using a single 3D representation that is selected, using dithering, or by interpolating between images rendered using multiple selected 3D representations.

In sum, techniques are disclosed for generating and utilizing a set of 3D representations, such as a set of NeRFs, of a scene. In some embodiments, a 3D representation generator segments out, from a set of captured images of the scene, predefined classes of objects that can move within the scene. Then, the 3D representation generator determines camera poses associated with each image in the set of captured images. The 3D representation generator assigns each of the images to one or more clusters based on an associated camera pose. For each cluster, the 3D representation generator generates a 3D representation based on the images assigned to the cluster. Once generated, the 3D representations can be streamed, or otherwise provided for use, and images can be rendered from different positions and view directions of a viewer using the 3D representations.

At least one technical advantage of the disclosed techniques relative to the prior art is that images rendered using the disclosed techniques can be less blurry and can include more detail relative to images rendered using conventional approaches, particular for large-scale scenes. In addition, the disclosed techniques permit processing parallelization, which can reduce the time required to generate 3D representations and to render images using those 3D representations relative to conventional approaches. These technical advantages represent one or more technological improvements over prior art approaches.

1. In some embodiments, a computer-implemented method for generating representations of scenes comprises assigning each image included in a set of images of a scene to one or more clusters of images based on a camera pose associated with the image, and performing one or more operations to generate, for each cluster included in the one or more clusters, a corresponding three-dimensional (3D) representation of the scene based on one or more images assigned to the cluster.

2. The computer-implemented method of clause 1, wherein assigning each image included in the set of images to one or more clusters of images comprises computing a point associated with each image based on the camera pose associated with the image, determining one or more cluster centers based on the point associated with each image, and assigning each image to one or more clusters based on distances from the point associated with the image to one or more cluster centers.

3. The computer-implemented method of clauses 1 or 2, wherein the point associated with each image is located at either a predefined distance or a computed distance from a camera that captured the image.

4. The computer-implemented method of any of clauses 1-3, wherein assigning each image included in the set of images to one or more clusters of images comprises computing a view ray associated with each image included in the set of images based on the camera pose associated with the image, and assigning each image included in the set of images to one or more clusters of images based on one or more points that are closest to the view rays that are computed.

5. The computer-implemented method of any of clauses 1-4, wherein each corresponding 3D representation comprises at least one of a neural radiance field (NeRF), a signed distance function (SDF), a set of points, a set of surfels (Surface Elements), a set of Gaussians, a set of tetrahedra, or a set of triangles.

6. The computer-implemented method of any of clauses 1-5, further comprising rendering an image based on at least one corresponding 3D representation of the scene that is located closer to a viewer with respect to a distance metric than at least one other corresponding 3D representation of the scene.

7. The computer-implemented method of any of clauses 1-6, further comprising rendering an image based on four corresponding 3D representations of the scene and barycentric coordinates associated with a viewer within a tetrahedron formed by the four corresponding 3D representations.

8. The computer-implemented method of any of clauses 1-7, further comprising rendering a plurality of images based on at least two of the corresponding 3D representations of the scene, and performing one or more operations to interpolate the plurality of images to generate an interpolated image.

9. The computer-implemented method of any of clauses 1-8, further comprising adding at least one image included in the set of images to a cluster included in the one or more clusters based on a view direction associated with the at least one image.

10. The computer-implemented method of any of clauses 1-9, further comprising, prior to assigning each image included in the set of images to one or more clusters of images, performing one or more operations to segment out one or more predefined classes of objects within each image included in the set of images.

11. In some embodiments, one or more non-transitory computer-readable media storing instructions that, when executed by at least one processor, cause the at least one processor to perform the steps of assigning each image included in a set of images of a scene to one or more clusters of images based on a camera pose associated with the image, and performing one or more operations to generate, for each cluster included in the one or more clusters, a corresponding three-dimensional (3D) representation of the scene based on one or more images assigned to the cluster.

12. The one or more non-transitory computer-readable media of clause 11, wherein assigning each image included in the set of images to one or more clusters of images comprises computing a point associated with each image based on the camera pose associated with the image, determining one or more cluster centers based on the point associated with each image, and assigning each image to one or more clusters based on distances from the point associated with the image to one or more cluster centers.

13. The one or more non-transitory computer-readable media of clauses 11 or 12, wherein determining the one or more cluster centers comprises performing one or more k-means clustering operations based on the points associated with the set of images.

14. The one or more non-transitory computer-readable media of any of clauses 11-13, wherein the instructions, when executed by the at least one processor, further cause the at least one processor to perform the step of rendering an image based on at least one corresponding 3D representation of the scene that is located closer to a viewer with respect to a distance metric than at least one other corresponding 3D representation of the scene.

15. The one or more non-transitory computer-readable media of any of clauses 11-14, wherein the instructions, when executed by the at least one processor, further cause the at least one processor to perform the step of rendering an image based on four corresponding 3D representations and barycentric coordinates associated with a viewer within a tetrahedron formed by the four corresponding 3D representations.

16. The one or more non-transitory computer-readable media of any of clauses 11-15, wherein one of the corresponding 3D representations of the scene is associated with a data structure that identifies a region of the scene that is larger in size than another region of the scene that is identified by another data structure associated with another one of the corresponding 3D representations of the scene.

17. The one or more non-transitory computer-readable media of any of clauses 11-16, wherein the instructions, when executed by the at least one processor, further cause the at least one processor to perform the step of adding at least one image included in the set of images to a cluster included in the one or more clusters based on a view direction associated with the at least one image.

18. The one or more non-transitory computer-readable media of any of clauses 11-17, wherein the instructions, when executed by the at least one processor, further cause the at least one processor to perform the step of prior to assigning each image included in the set of images to one or more clusters of images, performing one or more operations to segment out one or more predefined classes of objects within each image included in the set of images.

19. The one or more non-transitory computer-readable media of any of clauses 11-18, wherein the one or more predefined classes of objects include at least one class of objects that is able to move within the scene.

20. In some embodiments, a system comprises one or more memories storing instructions, and one or more processors that are coupled to the one or more memories and, when executing the instructions, are configured to assign each image included in a set of images of a scene to one or more clusters of images based on a camera pose associated with the image, and perform one or more operations to generate, for each cluster included in the one or more clusters, a corresponding three-dimensional (3D) representation of the scene based on one or more images assigned to the cluster.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating representations of scenes, the method comprising:
assigning each image included in a set of images of a scene to one or more clusters of images based on a camera pose associated with the image; and
performing one or more operations to generate, for each cluster included in the one or more clusters, a corresponding three-dimensional (3D) representation of the scene based on one or more images assigned to the cluster.

2. The computer-implemented method of claim 1, wherein assigning each image included in the set of images to one or more clusters of images comprises:
computing a point associated with each image based on the camera pose associated with the image;
determining one or more cluster centers based on the point associated with each image; and
assigning each image to one or more clusters based on distances from the point associated with the image to one or more cluster centers.

3. The computer-implemented method of claim 2, wherein the point associated with each image is located at either a predefined distance or a computed distance from a camera that captured the image.

4. The computer-implemented method of claim 1, wherein assigning each image included in the set of images to one or more clusters of images comprises:
computing a view ray associated with each image included in the set of images based on the camera pose associated with the image; and
assigning each image included in the set of images to one or more clusters of images based on one or more points that are closest to the view rays that are computed.

5. The computer-implemented method of claim 1, wherein each corresponding 3D representation comprises at least one of a neural radiance field (NeRF), a signed distance function (SDF), a set of points, a set of surfels (Surface Elements), a set of Gaussians, a set of tetrahedra, or a set of triangles.

6. The computer-implemented method of claim 1, further comprising rendering an image based on at least one corresponding 3D representation of the scene that is located closer to a viewer with respect to a distance metric than at least one other corresponding 3D representation of the scene.

7. The computer-implemented method of claim 1, further comprising rendering an image based on four corresponding 3D representations of the scene and barycentric coordinates associated with a viewer within a tetrahedron formed by the four corresponding 3D representations.

8. The computer-implemented method of claim 1, further comprising:
rendering a plurality of images based on at least two of the corresponding 3D representations of the scene; and
performing one or more operations to interpolate the plurality of images to generate an interpolated image.

9. The computer-implemented method of claim 1, further comprising adding at least one image included in the set of images to a cluster included in the one or more clusters based on a view direction associated with the at least one image.

10. The computer-implemented method of claim 1, further comprising, prior to assigning each image included in the set of images to one or more clusters of images, performing one or more operations to segment out one or more predefined classes of objects within each image included in the set of images.

11. One or more non-transitory computer-readable media storing instructions that, when executed by at least one processor, cause the at least one processor to perform the steps of:
assigning each image included in a set of images of a scene to one or more clusters of images based on a camera pose associated with the image; and
performing one or more operations to generate, for each cluster included in the one or more clusters, a corresponding three-dimensional (3D) representation of the scene based on one or more images assigned to the cluster.

12. The one or more non-transitory computer-readable media of claim 11, wherein assigning each image included in the set of images to one or more clusters of images comprises:
computing a point associated with each image based on the camera pose associated with the image;
determining one or more cluster centers based on the point associated with each image; and
assigning each image to one or more clusters based on distances from the point associated with the image to one or more cluster centers.

13. The one or more non-transitory computer-readable media of claim 11, wherein determining the one or more cluster centers comprises performing one or more k-means clustering operations based on the points associated with the set of images.

14. The one or more non-transitory computer-readable media of claim 11, wherein the instructions, when executed by the at least one processor, further cause the at least one processor to perform the step of rendering an image based on at least one corresponding 3D representation of the scene that is located closer to a viewer with respect to a distance metric than at least one other corresponding 3D representation of the scene.

15. The one or more non-transitory computer-readable media of claim 11, wherein the instructions, when executed by the at least one processor, further cause the at least one processor to perform the step of rendering an image based on four corresponding 3D representations and barycentric coordinates associated with a viewer within a tetrahedron formed by the four corresponding 3D representations.

16. The one or more non-transitory computer-readable media of claim 11, wherein one of the corresponding 3D representations of the scene is associated with a data structure that identifies a region of the scene that is larger in size than another region of the scene that is identified by another data structure associated with another one of the corresponding 3D representations of the scene.

17. The one or more non-transitory computer-readable media of claim 11, wherein the instructions, when executed by the at least one processor, further cause the at least one processor to perform the step of adding at least one image included in the set of images to a cluster included in the one or more clusters based on a view direction associated with the at least one image.

18. The one or more non-transitory computer-readable media of claim 11, wherein the instructions, when executed by the at least one processor, further cause the at least one processor to perform the step of prior to assigning each image included in the set of images to one or more clusters of images, performing one or more operations to segment out one or more predefined classes of objects within each image included in the set of images.

19. The one or more non-transitory computer-readable media of claim 18, wherein the one or more predefined classes of objects include at least one class of objects that is able to move within the scene.

20. A system, comprising:
one or more memories storing instructions; and
one or more processors that are coupled to the one or more memories and, when executing the instructions, are configured to:
assign each image included in a set of images of a scene to one or more clusters of images based on a camera pose associated with the image, and
perform one or more operations to generate, for each cluster included in the one or more clusters, a corresponding three-dimensional (3D) representation of the scene based on one or more images assigned to the cluster.
